(19) United States
(12) Patent Application Publication
(10) Pub. No.: US 2002/0004766 A1
(43) Pub. Date: Jan. 10, 2002

(54) Methods for permitting non-buyers to order items in an electronic commerce system

(75) Inventor: James E. White, Topsfield, MA (US)

Correspondence Address: Gary L. Loser, Varian Semiconductor Equipment, Associat Inc., 35 Dory Road, Gloucester, MA, 01930, US

(73) Assignee: Varian Semiconductor Equipment Associates, Inc., Gloucester, MA

(21) Appl. No.: 09/894,597

(22) Filed: Jun. 28, 2001

Related U.S. Application Data
(60) Provisional application No. 60/216,589, filed on Jul. 7, 2000.

(51) Int. Cl. G06F 17/60

(52) U.S. Cl. 705/27

(57) ABSTRACT

Methods for conducting electronic commerce include the steps of identifying items on a web site, registering on the web site an authorized individual associated with a customer, placing order selections of the items from a non-authorized individual associated with the customer in a sub tier electronic order, holding the sub tier electronic order for approval by the authorized individual, and converting the sub tier electronic order to an approved electronic order in response to approval by the authorized individual.

### CROSS REFERENCE TO RELATED APPLICATION

This application claims the benefit of provisional application Serial No. 60/216,589 filed Jul. 7, 2000, which is hereby incorporated by reference.

### FIELD OF THE INVENTION

This invention relates to methods for conducting electronic commerce and, more particularly, to methods for permitting individuals that do not have purchase authorization to order items in an electronic commerce system. The invention is particularly useful in business-to-business applications, but is not limited to such applications.

### BACKGROUND OF THE INVENTION

Electronic commerce has come into widespread use as Internet usage has increased. In its basic form, a supplier establishes a web site that identifies and describes items available for purchase. A prospective purchaser accesses the web site through the Internet and selects items to be purchased. The items may be selected by placing item identifiers and quantities in an electronic shopping cart. After all items of interest have been selected, payment is made, typically by charging a credit card or a customer account, and the order is finalized. The selected items are then shipped to the customer.

In the case of consumer purchases by electronic commerce, transactions are typically limited to persons having valid credit cards. In the case of business-to-business purchases by electronic commerce, the situation is somewhat different. The business customer may designate one or more buyers having authorization to make purchases from the supplier web site. The buyer selects items for purchase, typically using the shopping cart approach described above. The restriction of purchases to authorized buyers maintains control over the purchasing process.

A drawback to restricting purchases to authorized buyers is that the buyers frequently are not the individuals making the purchasing decisions. Instead, purchasing decisions may be made by engineers and other non-buyers involved in operation of the business. The non-buyers specify items to be purchased and notify the buyer by purchase requisition, telephone or the like. However, the non-buyers may not be aware of the items available from the supplier and may specify competing items from another supplier.

Accordingly, there is a need for electronic commerce methods wherein non-buyers can be involved in electronic purchasing, while actual orders can be restricted to authorized buyers.

### SUMMARY OF THE INVENTION

According to a first aspect of the invention, a method is provided for conducting electronic commerce. The method includes the steps of identifying items on a web site, registering on the web site an authorized individual associated with a customer, placing order selections of the items from a non-authorized individual associated with the customer in a sub tier electronic order, holding the sub tier electronic order for approval by the authorized individual, and converting the sub tier electronic order to an approved electronic order in response to approval by the authorized individual.

The authorized individual may be a buyer or a supervisor. The non-authorized individual may be an engineer or other individual involved in making purchasing decisions.

The method may further comprise a step of registering on the web site the non-authorized individual associated with the customer.

The sub tier electronic order mechanism may comprise a sub tier electronic shopping cart, and the approved electronic order mechanism may comprise an approved electronic shopping cart.

The items identified as available for purchase, for example, may include new products, parts, service contracts and equipment upgrades.

According to another aspect of the invention, a method for conducting electronic commerce is provided. The method comprises the steps of identifying items available for purchase on a web site, registering on the web site a buyer associated with a customer, registering on the web site a non-buyer associated with a customer, placing order selections of the items by the non-buyer in a sub tier electronic order, permitting the sub tier electronic order to be held for approval by the buyer, permitting the buyer to generate an approved electronic order based on the sub tier electronic order, receiving the approved electronic order from the buyer, and supplying items to the customer in accordance with the approved electronic order received from the buyer.

According to a further aspect of the invention, a method is provided for electronic ordering in a business entity. The method comprises the steps of authorizing a first individual associated with the business entity to place an order, authorizing a second individual associated with the business entity to place order selections in a sub tier electronic order, and converting the sub tier electronic order to an approved electronic order in response to approval by the first individual.

According to a further aspect of the invention, a method is provided for processing an order on a web site. The method comprises the steps of placing order selections by a non-authorized individual associated with a customer in a sub tier electronic order, and converting the sub tier electronic order to an approved electronic order in response to approval received from an authorized individual associated with the customer.

According to a further aspect of the invention, apparatus is provided for conducting electronic commerce. The apparatus comprises means for registering on a web site an authorized individual associated with a customer, means for placing order selections by a non-authorized individual associated with the customer in a sub tier electronic order, and means for converting the sub tier electronic order to an approved electronic order in response to approval received from the authorized individual.

### BRIEF DESCRIPTION OF THE DRAWINGS

For a better understanding of the present invention, reference is made to the accompanying drawings, which are incorporated herein by reference and in which:

FIG. 1 is a block diagram of a computer network suitable for implementing the present invention;

FIG. 2 is a flow chart of a method for electronic commerce in accordance with an embodiment of the invention;

FIG. 3 shows an order confirmation display screen in accordance with an embodiment of the invention; and

FIG. 4 shows an electronic shopping cart display screen in accordance with an embodiment of the invention.

### DETAILED DESCRIPTION

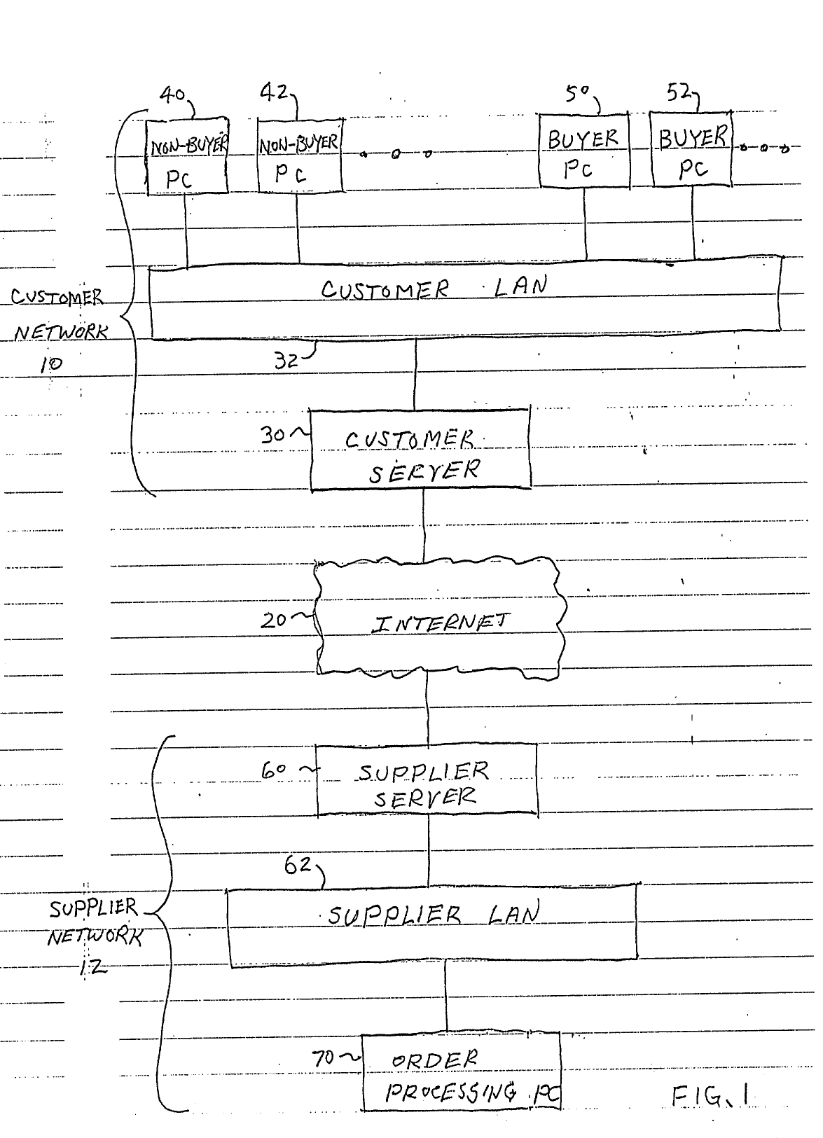

A system suitable for implementing the present invention is shown in FIG. 1. A customer network 10 is electronically connected to a supplier network 12 by the Internet 20. The customer network 10 may be located in a customer facility, and the supplier network 12 may be located in a supplier facility. The customer network 10 includes a customer server 30 coupled to the Internet 20 and to a customer Local Area Network (LAN) 32. Customer Personal Computers (PCs) are connected to the customer LAN 32. The Customer PCs may include one or more non-buyer PCs 40, 42, etc. and one or more buyer PCs 50, 52, etc. Supplier network 12 includes a supplier server 60 coupled to Internet 20 and to a supplier LAN 62. Supplier PCs, including one or more order processing PC 70, are connected to supplier LAN 62.

To facilitate purchase of items from the supplier by electronic commerce, the supplier establishes a web site. The web site contains information concerning items available for purchase from the supplier. The web site may contain information concerning new products, parts for products, service contracts, and hardware and software upgrades, for example. The information concerning each item may include a part number, a description, a price and delivery information. The web site may reside on supplier server 60 or may reside at a remote location connected to Internet 20.

Individuals at the customer facility may place orders for items available on the supplier web site by accessing the supplier web site through Internet 20. For example, a buyer at buyer PC 50 may access the supplier web site and select items for purchase. The web site may utilize an order entry mechanism known as an electronic shopping cart. The desired items are placed in the electronic shopping cart electronically, and a running total cost may be maintained. When all of the desired items have been placed in the electronic shopping cart, the buyer may check out and finalize the order. Payment may be made by credit card or by purchase order number, if the customer has an account with the supplier. Upon finalization of the order, the order is filled by the supplier.

As noted above, businesses usually restrict purchasing authority to designated buyers. Other individuals in the business are not given purchasing authority and must purchase items for the business through an authorized buyer. While this approach maintains control of purchasing in a few authorized buyers, it restricts the freedom of non-authorized individuals within the customer business, such as engineers, to purchase items from the supplier. Furthermore, the conventional procedure, wherein the non-authorized individual submits a purchase requisition to a buyer and the buyer places an order, is inefficient.

In accordance with a feature of the invention, non-authorized individuals, such as engineers and other individuals having a need to purchase items from the supplier, are permitted to participate in the order process by selecting items and placing them in an electronic order mechanism, referred to for convenience as a sub tier shopping cart. A non-authorized individual, such as an engineer, accesses the supplier web site and reviews the information concerning items available for purchase. Items of interest are selected and placed in the sub tier electronic shopping cart. The non-authorized individual, after selecting items and placing them in the sub tier shopping cart, may park the shopping cart for later review and approval by an authorized individual, such as a buyer or a supervisor. The sub tier electronic shopping cart may be assigned an identification (ID). In one approach, the sub tier shopping cart ID may be e-mailed by the non-authorized individual to the authorized individual. In another approach, the entire sub tier shopping cart may be e-mailed to the authorized individual. The authorized individual reviews the items in the sub tier shopping cart and approves some or all of the items for purchase. The sub tier shopping cart is then converted to an approved shopping cart and the order is entered with the supplier by the authorized individual. This approach avoids the need for the unauthorized individuals to request purchases by telephone or purchase requisition sent to the authorized individual.

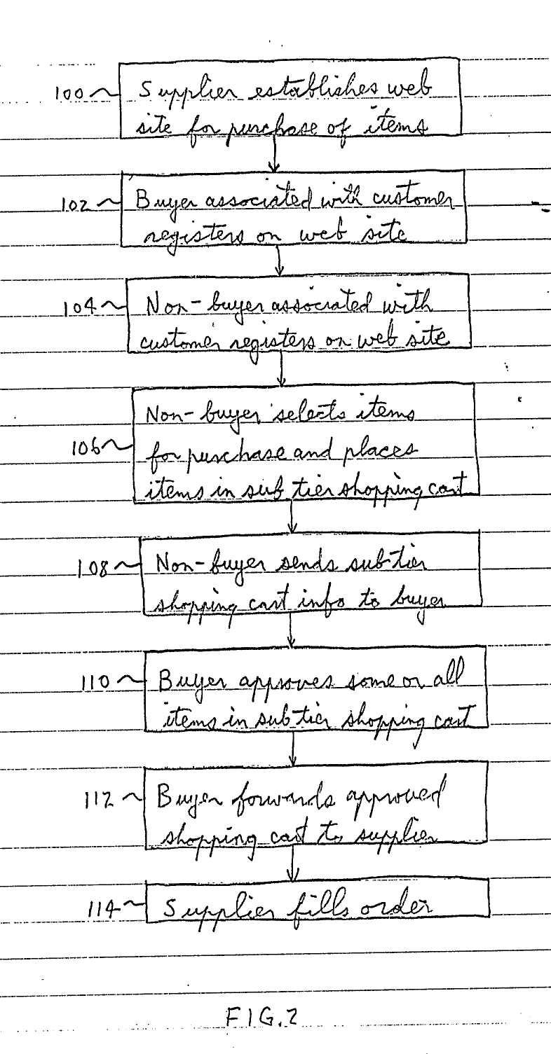

A flow chart of a process for electronic commerce in accordance with an embodiment of the invention is shown in FIG. 2. In step 100, the supplier establishes a web site for purchase of items. The web site identifies the items as described above and provides mechanisms for order entry by customers through the Internet. In step 102, an authorized individual associated with a customer, such as a buyer or a supervisor, registers on the web site. In step 104, a non-authorized individual, such as an engineer or other non-buyer associated with the customer, registers on the supplier web site. In step 106, the non-buyer selects items for purchase from the web site and places the items in a sub tier electronic shopping cart. In step 108, the non-buyer sends the sub tier electronic shopping cart to the authorized buyer. As noted above, this may be accomplished by sending the ID of the sub tier electronic shopping cart to the buyer by e-mail. In step 110, the buyer approves some or all of the items in the sub tier electronic shopping cart. In step 112, the buyer forwards the approved electronic shopping cart to the supplier web site as an approved order. In step 114, the supplier fills the approved order.

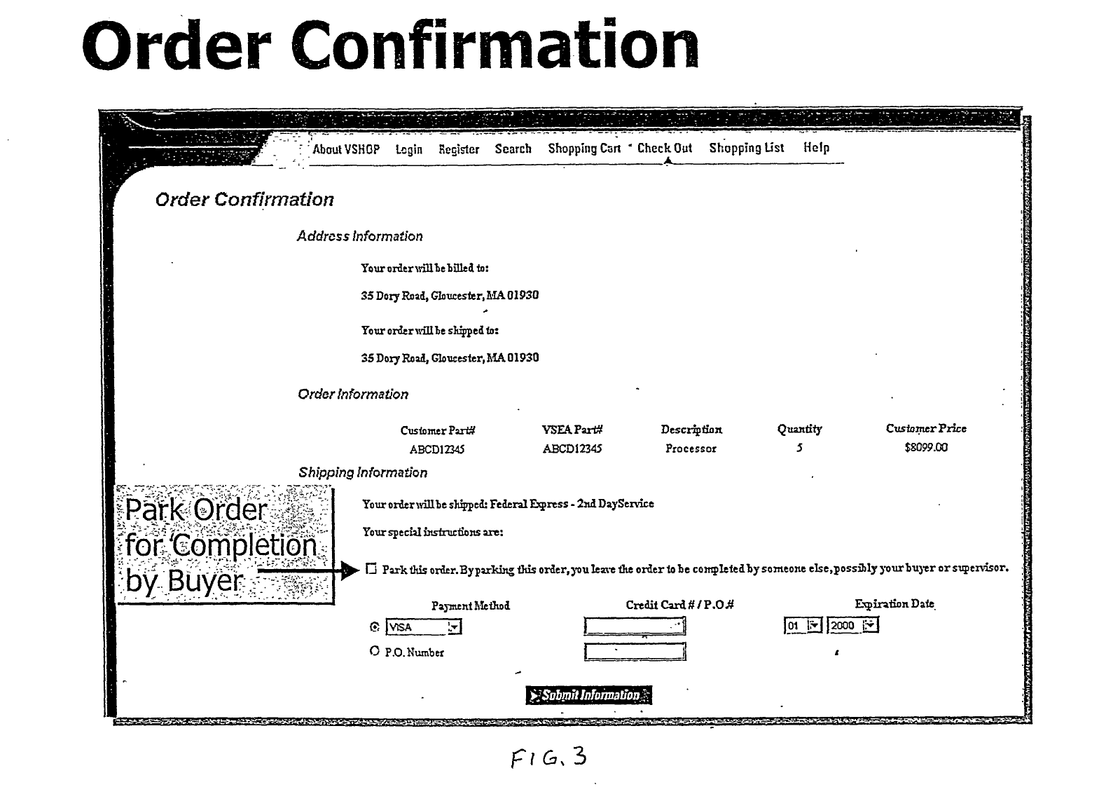

An example of an order confirmation screen generated by the supplier web site is shown in FIG. 3. The order confirmation screen includes an option for “parking” the order. This permits the non-authorized individual to park the shopping cart, or place the order on hold, for review and approval by the authorized individual. After the order is parked, the unauthorized individual may e-mail or otherwise notify the authorized buyer to obtain approval of the order.

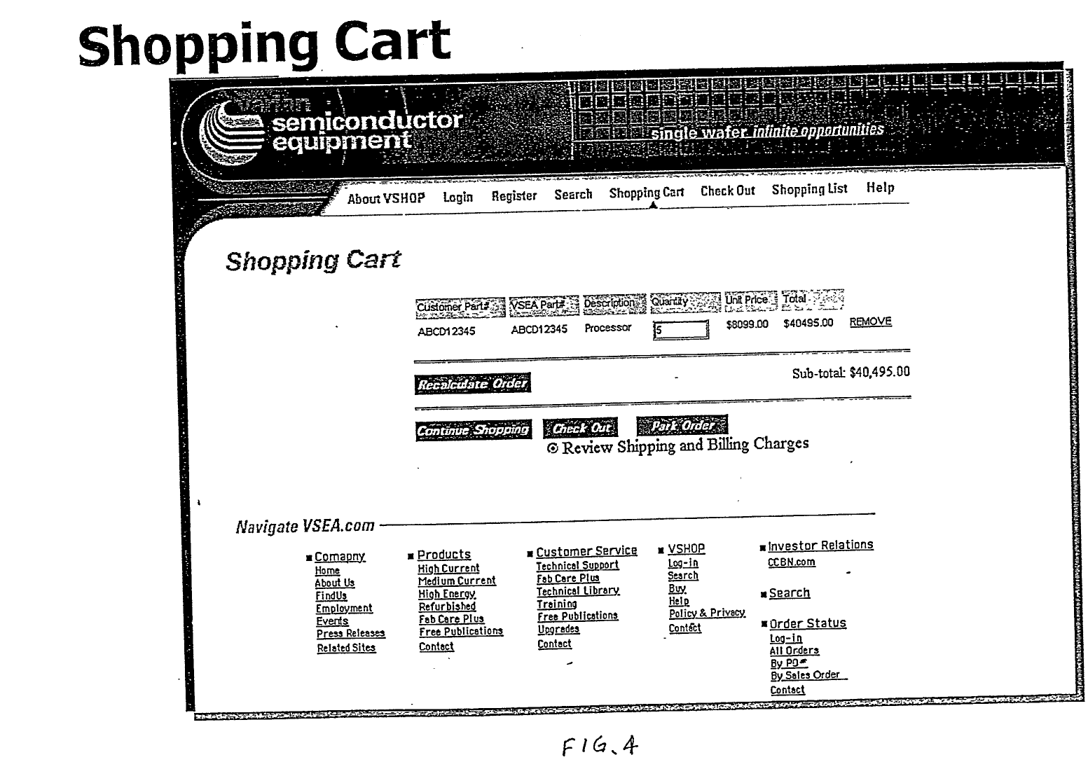

An example of a shopping cart screen generated by the supplier web site is shown in FIG. 4. The shopping cart provides information concerning selected items and a subtotal. As in the case of the order confirmation screen, the shopping cart screen provides the ability to park the order for subsequent approval by an authorized individual and submission of the approved order to the supplier.

In one example, the electronic commerce method described above may be used by a semiconductor fabrication facility and suppliers of equipment and parts to the semiconductor fabrication facility. Engineers involved in operation of a fab line, although not authorized to make purchases, may utilize a supplier web site as described above to initiate purchases through an authorized buyer.

While there have been shown and described what are at present considered the preferred embodiments of the present invention, it will be obvious to those skilled in the art that various changes and modifications may be made therein without departing from the scope of the invention as defined by the appended claims.

What is claimed is:

1. A method for conducting electronic commerce, comprising the steps of:
identifying items on a web site;
registering on the web site an authorized individual associated with a customer;
placing order selections of the items from a non-authorized individual associated with the customer in a sub tier electronic order;
holding the sub tier electronic order for approval by the authorized individual; and
converting the sub tier electronic order to an approved electronic order in response to approval by the authorized individual.

2. A method as defined in claim 1 further comprising the step of registering on the web site the non-authorized individual associated with the customer.

3. A method as defined in claim 1 wherein the sub tier electronic order comprises a sub tier shopping cart and wherein the approved electronic order comprises an approved shopping cart.

4. A method as defined in claim 1 wherein the step of identifying items available for purchase comprises identifying parts available for purchase.

5. A method as defined in claim 1 wherein the step of identifying items available for purchase comprises identifying service contracts available for purchase.

6. A method as defined in claim 1 wherein the step of identifying items available for purchase comprises identifying equipment upgrades available for purchase.

7. A method as defined in claim 1 further comprising the step of processing the approved electronic order.

8. A method as defined in claim 1 wherein the step of identifying items comprises identifying items suitable for use in a wafer fabrication facility and wherein said non-authorized individual comprises an engineer involved in the operation of said wafer fabrication facility.

9. A method for conducting electronic commerce, comprising the steps of:
identifying items available for purchase on a web site;
registering on the web site a buyer associated with a customer;
registering on the web site a non-buyer associated with the customer;
placing order selections of the items by the non-buyer in a sub tier electronic order;
permitting the sub tier electronic order to be held for approval by the buyer;
permitting the buyer to generate an approved electronic order based on the sub tier electronic order;
receiving the approved electronic order from the buyer; and
supplying items to the customer in accordance with the approved electronic order received from the buyer.

10. A method as defined in claim 9 wherein the sub tier electronic order comprises a sub tier shopping cart and wherein the approved electronic order comprises an approved shopping cart.

11. A method as defined in claim 9 wherein the step of identifying items comprises identifying items suitable for use in a wafer fabrication facility.

12. A method for electronic ordering in a business entity, comprising the steps of:
authorizing a first individual associated with the business entity to place an order;
authorizing a second individual associated with the business entity to place order selections in a sub tier electronic order; and
converting the sub tier electronic order to an approved electronic order in response to approval by the first individual.

13. A method as defined in claim 12 wherein the step of authorizing a first individual comprises the step of registering the first individual on a web site of a supplier.

14. A method as defined in claim 12 wherein the sub tier electronic order comprises a sub tier shopping cart and wherein the approved electronic order comprises an approved shopping cart.

15. A method for processing an order on a web site, comprising the steps of:
placing order selections by a non-authorized individual associated with a customer in a sub tier electronic order; and
converting the sub tier electronic order to an approved electronic order in response to approval received from an authorized individual associated with the customer.

16. A method as defined in claim 15 further comprising the step of registering on the web site the authorized individual associated with the customer.

17. A method as defined in claim 15 wherein the sub tier electronic order comprises a sub tier shopping cart and wherein the approved electronic order comprises an approved shopping cart.

18. A method as defined in claim 15 further comprising the step of identifying on the web site items suitable for use in a wafer fabrication facility.

19. A method for processing an order on a web site, comprising the steps of:
registering on the web site an authorized individual associated with a customer;
placing order selections by a non-authorized individual associated with the customer in a sub tier electronic order; and
converting the sub tier electronic order to an approved electronic order in response to approval received from the authorized individual.

20. A method as defined in claim 19 wherein the sub tier electronic order comprises a sub tier shopping cart and wherein the approved electronic order comprises an approved shopping cart.

21. A method as defined in claim 19 further comprising the step of processing the approved electronic order.

22. A method as defined in claim 19 further comprising the step of identifying on the web site items available for purchase.

23. A method as defined in claim 19 further comprising the step of identifying on the web site items suitable for use in a wafer fabrication facility.

24. Apparatus for conducting electronic commerce comprising:
means for registering on a web site an authorized individual associated with a customer;
means for placing order selections by a non-authorized individual associated with the customer in a sub tier electronic order; and
means for converting the sub tier electronic order to an approved electronic order in response to approval received from the authorized individual.
